(19) United States
(12) Patent Application Publication
(10) Pub. No.: US 2025/0091517 A1
(43) Pub. Date: Mar. 20, 2025

(54) ADDITIVELY MANUFACTURED HEATED RUNNING BOARD AND SYSTEM FOR A MOTOR VEHICLE

(71) Applicant: Ford Global Technologies, LLC, Dearborn, MI (US)

(72) Inventors: Keith Weston, Canton, MI (US); David D. Friske, Wolverine Lake, MI (US); Brendan Diamond, Grosse Pointe, MI (US)

(73) Assignee: Ford Global Technologies, LLC, Dearborn, MI (US)

(21) Appl. No.: 18/470,022

(22) Filed: Sep. 19, 2023

(51) Int. Cl. B60R 3/00; B33Y 80/00; B60S 1/66

(52) U.S. Cl. CPC B60R 3/002; B60S 1/66; B33Y 80/00

(57) ABSTRACT

A heated running board for a motor vehicle includes a substrate formed by an additive manufacturing process and a pre-fabricated heater embedded within the substrate. The pre-fabricated heater is not formed by the additive manufacturing process. A system for operating a heated running board for a motor vehicle includes the heated running board, at least one sensor, and a controller. The controller is configured to receive signals from the at least one sensor and supply power to the pre-fabricated heater to control a temperature of the pre-fabricated heater based on at least one operational characteristic from the at least one sensor.

### FIELD

The present disclosure relates to running boards for motor vehicles, and more particularly to a method of manufacturing and system for operating a heated running board.

### BACKGROUND

The statements in this section merely provide background information related to the present disclosure and may not constitute prior art.

Motor vehicles are commonly equipped with running boards extending along an entry area of the motor vehicle to assist a passenger with entering and exiting the motor vehicle. In some motor vehicles, the running boards are permanently attached to a side of the motor vehicle and in other configurations they may be deployed when a door of the motor vehicle is opened. In both cases, however, because they are on an exterior of the motor vehicle, they are subject to weather and other elements. For instance, they may become covered with dirt, they may become wet, or they may become ice-covered in certain weather situations.

The present disclosure addresses these issues related to running boards that become covered with dirt, debris, or ice.

### SUMMARY

This section provides a general summary of the disclosure and is not a comprehensive disclosure of its full scope or all of its features.

In one form, the present disclosure provides a heated running board for a motor vehicle. The heated running board comprises a substrate formed by an additive manufacturing process and a pre-fabricated heater embedded within the substrate. The pre-fabricated heater is not formed by the additive manufacturing process.

In variations of this heated running board, which may be implemented individually or in any combination: the substrate comprises a plurality of apertures, and the pre-fabricated heater defines a trace pattern extending around the plurality of apertures; the heated running board further comprises a plurality of LEDs (light-emitting diodes) embedded within the substrate and positioned across at least a portion of the plurality of apertures; the pre-fabricated heater comprises a resistive heating element surrounded by a dielectric core, the dielectric core being surrounded by a protective sheath; the pre-fabricated heater comprises a radiant fluid channel configured to accommodate a heating fluid; the pre-fabricated heater is disposed proximate an upper surface of the substrate; the heated running board further comprises an ice detector embedded within the substrate; the heated running board further comprises at least one temperature sensor embedded within the substrate; the substrate is a monolithic material; the heated running board further comprises a plurality of embedded pre-fabricated heaters disposed in predetermined locations along a length of the substrate; each of the plurality of pre-fabricated heaters is independently controlled; and the heated running board further comprises an electronic circuit embedded within the substrate.

The present disclosure further provides a heated running board for a motor vehicle. The heated running board comprises a substrate formed by an additive manufacturing process, a pre-fabricated heater embedded within the substrate and disposed proximate an upper surface of the substrate, and a plurality of LEDs (light-emitting diodes) embedded within the substrate. The substrate comprises a plurality of apertures. The pre-fabricated heater defines a trace pattern extending around the plurality of apertures. The LEDs are positioned across at least a portion of the plurality of apertures.

In yet another form, the present disclosure provides a system for operating a heated running board for a motor vehicle. The system comprises a heated running board, at least one sensor, and a controller. The heated running board comprises a substrate formed by an additive manufacturing process and a pre-fabricated heater embedded within the substrate. The controller is configured to receive signals from the at least one sensor and supply power to the pre-fabricated heater to control a temperature of the pre-fabricated heater based on at least one operational characteristic from the at least one sensor.

In variations of this system, which may be implemented individually or in any combination: the at least one sensor is a temperature sensor, and the at least one operational characteristic is outside air temperature (OAT); the at least one sensor is a vibration sensor, and the at least one operational characteristic is ice accumulation; the at least one sensor is an external camera mounted to the motor vehicle, and the at least one operational characteristic is foreign substance accumulation along the substrate; the at least one sensor is a resistive heating element of the pre-fabricated heater, the resistive heating element defining a sufficient temperature coefficient of resistance to function as a heater and as a sensor; the controller provides power to the pre-fabricated heater based on a predetermined schedule when the motor vehicle is started; and the controller is configured to deploy the heated running board based on the at least one operational characteristic.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a motor vehicle having a heated running board constructed in accordance with the teachings of the present disclosure;

FIG. 2 is a top perspective view of one form of the heated running board of FIG. 1;

FIG. 3 a cross-sectional view, taken along line 3-3 of FIG. 2, of the heated running board of FIG. 1;

FIG. 4 is a perspective cutaway view of a tubular heater constructed in accordance with the teachings of the present disclosure;

FIG. 5 is a flow diagram illustrating a method of manufacturing the heated running board in accordance with the teachings of the present disclosure; and

FIG. 6 is a schematic diagram illustrating a system for operating the heated running board in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

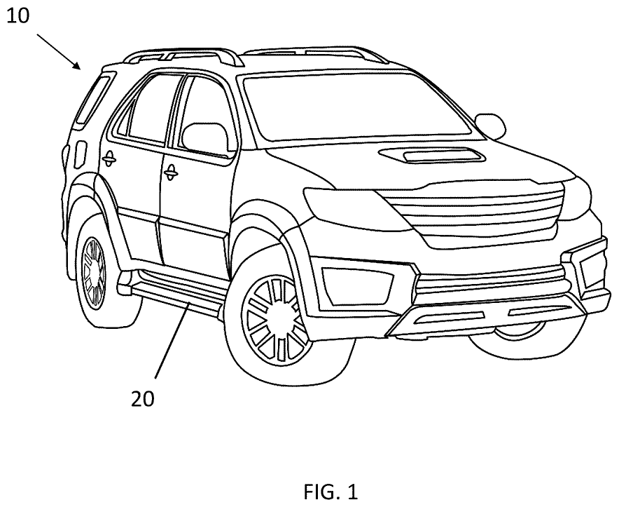

Referring to FIGS. 1-3, a heated running board 20 for an exemplary motor vehicle 10 is shown. The heated running board 20 is configured as a long approximately rectangular surface that is disposed along the motor vehicle 10 to assist a passenger to enter or exit the motor vehicle 10. In one form (not shown), the heated running board 20 is configured to extend from a retracted position into an extended position and back in order to provide a streamlined shape to the motor vehicle 10.

The heated running board 20 generally comprises a substrate 22 formed by an additive manufacturing process, and a pre-fabricated heater 24 embedded within the substrate 22. As set forth in greater detail below, the pre-fabricated heater 24 is not formed by an additive manufacturing process and is instead pre-formed, or fabricated in advance of the actual additive manufacturing process that forms the substrate 22 and embeds the pre-fabricated heater 24 within the substrate 22.

The substrate 22 is made by an additive manufacturing method, as set forth in greater detail below. Because the substrate 22 is made by additive manufacturing techniques, the substrate 22 can be made as a single integral component, as opposed to an assembly of individual component parts. The integral structure of the substrate 22 thus reduces potential stresses caused by welds or other joining methods, such as mechanical, and also provides flexibility to be able to embed other components besides the pre-fabricated heater 24, as set forth in greater detail below.

In one form, the substrate 22 is made of a metal such as aluminum, stainless steel, or mild steel. In another form, the substrate 22 is made of a polymer such as acrylonitrile butadiene styrene (ABS), polyamides, polypropylene, and the like. In yet another form, the substrate 22 may be made of a composite or hybrid material, such as by way of example, a thermoset or thermoplastic matrix with embedded fibers. In one form, the substrate 22 is monolithic, i.e., the same material throughout with the same material properties in every direction. In another form, more than one type of material, e.g., a polymer on the bottom and an aluminum material on the top, may be used in manufacturing the substrate 22. Further examples and details of various additive manufacturing methods are provided in greater detail below.

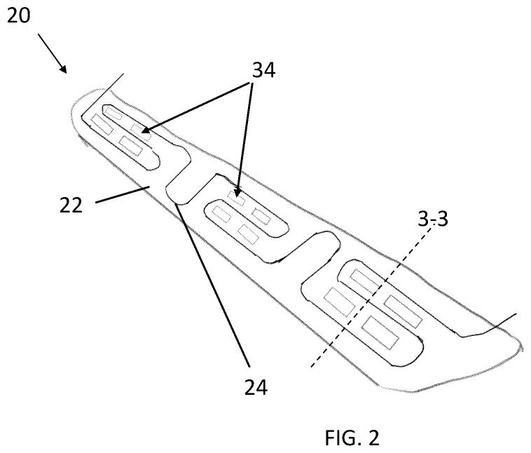

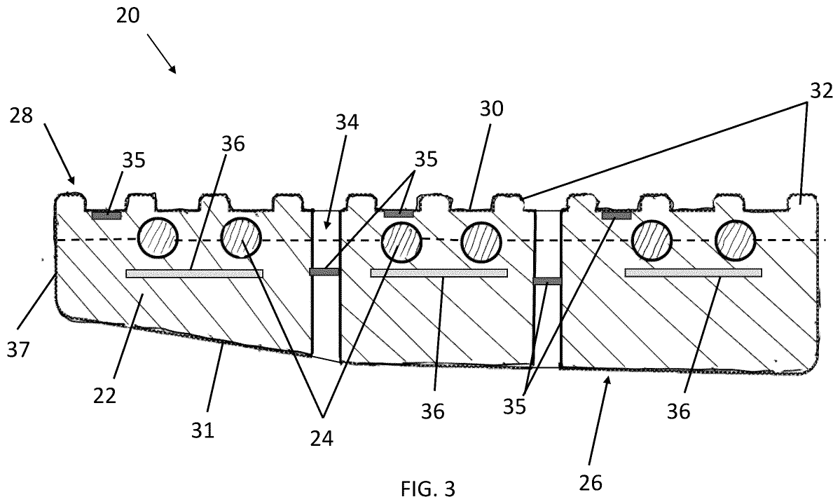

Referring specifically to FIG. 3, the substrate 22 includes a lower portion 26 and an upper portion 28. The upper portion 28 includes an upper surface 30, and in one form includes a plurality of projections 32. The optional projections 32 (or other surface shaping/texturing) provide more traction on the upper surface 30 for an operator and/or passenger. As further shown, the substrate 22 comprises a plurality of apertures 34 (also shown in FIG. 2), or openings extending through the substrate 22 from the upper surface 30 to a lower surface 31. The apertures 34 are generally provided to reduce the weight of the overall heated running board 20, while also providing drainage for precipitation or debris that may form on the upper surface 30 of the heated running board 20. In another form not shown, the heated running board 20 does not include any apertures 34.

The pre-fabricated heater 24 is embedded within the substrate 22 between the lower portion 26 and the upper portion 28, and in this form is disposed proximate the upper surface 30 of the substrate 22. This places the heat from the pre-fabricated heater 24 closer to the ice/buildup on the upper surface 30 and aids in providing improved traction on the upper surface 30 of the heated running board 20. It should be understood, however, the pre-fabricated heater 24 may be placed at any of a number of locations within the substrate 22 as a function of specific application requirements while falling within the scope of the present disclosure.

Referring also to FIG. 2, the pre-fabricated heater 24 defines a trace pattern (or path) extending around the plurality of apertures 34 as shown. The trace pattern is configured to provide heat in predetermined areas of the substrate 22, and the trace pattern as shown is thus merely exemplary.

In one form not shown, the heated running board 20 comprises a plurality of embedded pre-fabricated heaters 24 disposed in predetermined locations along a length of the substrate 22. Each of the plurality of pre-fabricated heaters 24 may be independently controlled or alternatively, some of the plurality of pre-fabricated heaters 24 may be controlled together or simultaneously.

Referring back to FIG. 3, in one form, the heated running board 20 further comprises a plurality of LEDs (light-emitting diodes) 35 embedded within the substrate 22 and positioned across at least a portion of the plurality of apertures 34. The LEDs 35 illuminate the heated running board 20 and thus help an operator or passenger more easily locate and place their foot on the heated running board 20. The LEDs 35 may also be located in other areas of the heated running board 20 while remaining within the scope of the present disclosure, and thus those locations illustrated herein are merely exemplary. For example, the LEDs 35 could be located at an outer edge 37 so that the heated running board 20 is visible from an exterior of the motor vehicle 10.

In an additional form, at least one sensor 62 is embedded within the substrate 22. A variety of types of sensors 62 may be utilized, including but not limited to an ice detector or a temperature sensor. The sensors 62 are described in greater detail below.

The heated running board 20 further comprises an electronic circuit 36 embedded within the substrate 22. The electronic circuit 36 is used to provide power to the pre-fabricated heater 24, the LEDs 35, sensors 62, or any other electrical components in or on the substrate 22. The electronic circuit 36 can also be used to receive communication from controllers 64 or sensors 62 on the motor vehicle 10.

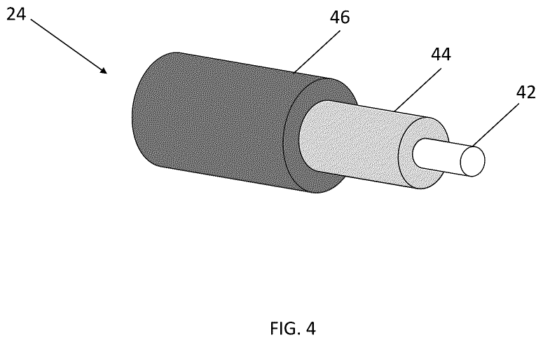

As previously set forth, the pre-fabricated heater 24 is pre-formed, or manufactured in advance of being embedded into the substrate 22 during the additive manufacturing process. Thus, the pre-fabricated heater 24 is not manufactured by additive manufacturing at the same time as the substrate 22 is being formed by additive manufacturing. In one form, as shown in FIG. 4, the pre-fabricated heater 24 is a “tubular” heater construction, which generally comprises a resistive heating element 42 surrounded by a dielectric core 44, the dielectric core 44 being surrounded by a protective sheath 46. The resistive heating element 42 may also define a sufficient temperature coefficient of resistance (TCR) to function as both a heater 24 and a temperature sensor (i.e., changes in resistance are calibrated to the TCR characteristics of the resistive heating element 42 to calculate the temperature). In another form, the pre-fabricated heater 24 is a radiant fluid channel (not shown) configured to accommodate a heating fluid being provided/routed from the systems of the motor vehicle 10 (e.g., engine cooling fluid).

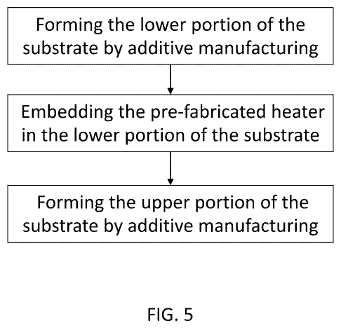

Referring now to FIG. 5, a method of manufacturing the heated running board 20 is illustrated. First, the lower portion 26 of the substrate 22 is manufactured by additive manufacturing. For example, in one form the lower portion of the substrate 22 is manufactured by fused filament fabrication, in which a plurality of layers of a polymer are built up until the required shape is formed, Next, the pre-fabricated heater 24 is placed onto the lower portion 26 of the substrate 22. In one form, a recess is left in the lower portion 26 during printing in which the pre-fabricated heater 24 is placed. Finally, the upper portion 28 of the substrate 22 is manufactured by additive manufacturing, thereby embedding or encapsulating the pre-fabricated heater 24. In additional variations of this method, additional components such as the electric circuit 36, LEDs 35, or sensors 62 are also embedded within the substrate 22 at specific predetermined locations, similar to the pre-fabricated heater 24.

The substrate 22 is additively manufactured using known, or yet to be developed, additively manufactured techniques. In one form, the substrate 22 is manufactured from a metal powder by methods such as but not limited to selective laser melting (SLM), direct metal laser sintering (DMSL), direct metal laser melting (DMLM), and electron beam melting (EBM). In another form, the substrate 22 is manufactured from a polymer by methods such as but not limited to fused filament fabrication (FFF), selective laser sintering (SLS), stereolithography (SLA) and the like.

Additive manufacturing provides flexibility in producing a heated running board with a substrate with embedded components (e.g., pre-fabricated heater 24, LEDs 35, sensors 62) while allowing for a varying composition through the volume of the heated running board 20. For example, the upper portion 28 may be a wear-resistant material such as ABS or nylon while the lower portion 26 is a lower density material such as polypropylene to save weight. In one form, the substrate 22 is additively manufactured to include a plurality of small voids in predetermined locations such that the density of the substrate varies through the volume of the heated running board 20.

Thus, the heated running board 20 has a number of distinctive structural characteristics by virtue of the additive manufacturing process combined with a pre-fabricated heater 24. For example, the properties of the substrate 22 are tailored to the specific application and further are tailored to the requirements of specific locations in the heated running board by varying the material and/or material properties. In addition, the embedded components (pre-fabricated heater 24, sensors 62, LEDs 35, electronic circuits 36) can be disposed at any location in the substrate 22, real-time and without dedicated tooling, thus further tailoring the design to a specific application. The tailored location of the pre-fabricated heater 24 also allows for precise heat delivery to the specific locations of the heated running board 20, by adjusting the path/trace or the distance of the pre-fabricated heater 24 from the upper surface 30. Moreover, because additive manufacturing produces an integrated substrate without joints or seams, the heated running board 20 has a higher strength and lighter weight than with conventional manufacturing techniques.

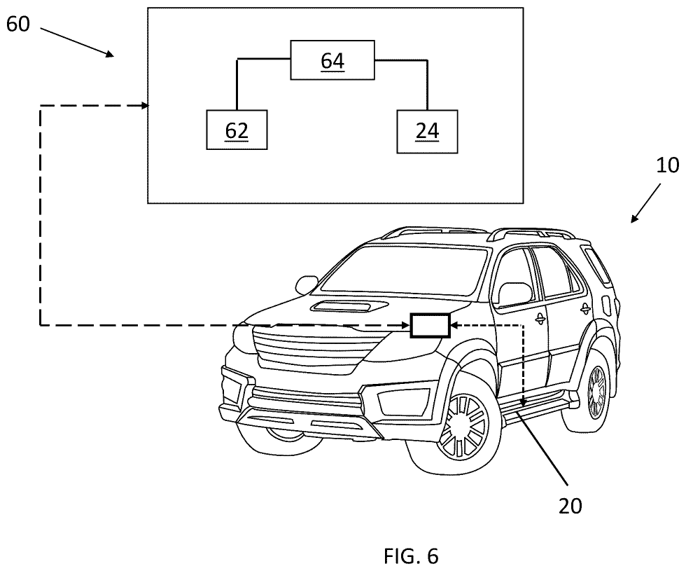

With reference now to FIG. 6, a system 60 for operating the heated running 20 board is shown integrated with an exemplary motor vehicle 10. The system 60 includes the heated running board 20 as described above, and at least one sensor 62 in communication with a controller 64. As set forth in more detail below, the controller 64 is configured to receive signals from the sensors 62 and supply power to the pre-fabricated heater 24 to control a temperature of the pre-fabricated heater 24 based on at least one operational characteristic from the sensors 62.

The at least one sensor 62 detects at least one operational characteristic. The at least one operational characteristic may include any of a variety of ambient outside conditions and/or motor vehicle conditions. The operational characteristics may include, by way of example, temperature, vibration, light, ice accumulation, or motor vehicle speed, among others. In one form, the sensor 62 is a temperature sensor, and the operational characteristic is the outside air temperature or a temperature of the upper surface of the heated running board 20. The resistive heater 24 element of the pre-fabricated heater 24 can function as a temperature sensor or a separate temperature sensor can be included. In another form, the sensor 62 is a vibration sensor, and the operational characteristic is ice accumulation on the heated running board 20. If the heated running board 20 is retractable, torque sensors 62 can identify ice accumulation, in addition to or in place or vibration sensors. In yet another form, the sensor 62 is a camera, and the operational characteristic is foreign substance accumulation on the substrate 22, which may include ice, or a mixture of ice and mud. The camera may also be used to identify snow or ice in the motor vehicle 10 surroundings indicating potentially ice-forming conditions. The LEDs embedded in the substrate 22 can be used to aid in visual identification of substance accumulation. Other types of sensors 62 and operational characteristics may be utilized within the scope of the present disclosure. In addition, the various forms may be used in any combination. The sensors 62 are located on the motor vehicle 10 and may be embedded in the substrate 22, otherwise attached to the heated running board 20, or placed at another location on the motor vehicle 10.

The controller 64 is coupled to the at least one sensor 62 which measures or detects ambient outside conditions and motor vehicle conditions. In one form, the controller 64 is a part of an electronic control unit (ECU) of the motor vehicle 10, which controls one or more electrical systems of the motor vehicle 10. In another form, the controller 64 is also configured to deploy or retract the heated running board 20 based on the at least one operational characteristic. The controller 64 is configured as would be understood in the art, and in one form includes a processor and memory.

The controller 64 is configured to send power to the pre-fabricated heater 24 based on the signals received from the sensors 62, to apply heat to the heated running board 20. In one form, if the input from the sensors 62 indicates that an operational characteristic has met a predetermined threshold or range, the controller will send power to the pre-fabricated heater 24. The controller can continue to send power to the pre-fabricated heater 24 until the operational characteristic is no longer within the pre-determined range. Alternatively, the controller 64 may provide power to the pre-fabricated heater 24 for a period of time. In another form, the controller 64 may cycle the pre-fabricated heater 24 on and off at predetermined intervals until the operational characteristic is no longer within the predetermined range.

In one form, the controller 64 provides power to the pre-fabricated heater 24 based on a predetermined schedule from an event such as when the motor vehicle 10 is started or turned off. In another form, the controller 64 provides power to the pre-fabricated heater 24 based on a weather forecast or other additional input. These and other various control schemes may be employed as a function of specific operational requirements or user preferences while remaining within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A heated running board for a motor vehicle, the heated running board comprising:
a substrate formed by an additive manufacturing process; and
a pre-fabricated heater embedded within the substrate, wherein the pre-fabricated heater is not formed by the additive manufacturing process.

2. The heated running board according to claim 1, wherein the substrate comprises a plurality of apertures, and the pre-fabricated heater defines a trace pattern extending around the plurality of apertures.

3. The heated running board according to claim 2, further comprising a plurality of LEDs (light-emitting diodes) embedded within the substrate and positioned across at least a portion of the plurality of apertures.

4. The heated running board according to claim 1, wherein the pre-fabricated heater comprises a resistive heating element surrounded by a dielectric core, the dielectric core being surrounded by a protective sheath.

5. The heated running board according to claim 1, wherein the pre-fabricated heater comprises a radiant fluid channel configured to accommodate a heating fluid.

6. The heated running board according to claim 1, wherein the pre-fabricated heater is disposed proximate an upper surface of the substrate.

7. The heated running board according to claim 1, further comprising an ice detector embedded within the substrate.

8. The heated running board according to claim 1, further comprising at least one temperature sensor embedded within the substrate.

9. The heated running board according to claim 1, wherein the substrate is a monolithic material.

10. The heated running board according to claim 1, further comprising a plurality of embedded pre-fabricated heaters disposed in predetermined locations along a length of the substrate.

11. The heated running board according to claim 10, wherein each of the plurality of pre-fabricated heaters is independently controlled.

12. The heated running board according to claim 1, further comprising an electronic circuit embedded within the substrate.

13. A heated running board for a motor vehicle, the heated running board comprising:
a substrate formed by an additive manufacturing process;
a pre-fabricated heater embedded within the substrate, the pre-fabricated heater being disposed proximate an upper surface of the substrate; and
a plurality of LEDs (light-emitting diodes) embedded within the substrate,
wherein the substrate comprises a plurality of apertures, and the pre-fabricated heater defines a trace pattern extending around the plurality of apertures, and
wherein the LEDs are positioned across at least a portion of the plurality of apertures.

14. A system for operating a heated running board for a motor vehicle, the system comprising:
a heated running board, the heated running board comprising a substrate formed by an additive manufacturing process and a pre-fabricated heater embedded within the substrate;
at least one sensor; and
a controller, wherein the controller is configured to receive signals from the at least one sensor and supply power to the pre-fabricated heater to control a temperature of the pre-fabricated heater based on at least one operational characteristic from the at least one sensor.

15. The system according to claim 14, wherein the at least one sensor is a temperature sensor, and the at least one operational characteristic is outside air temperature (OAT).

16. The system according to claim 14, wherein the at least one sensor is a vibration sensor, and the at least one operational characteristic is ice accumulation.

17. The system according to claim 14, wherein the at least one sensor is an external camera mounted to the motor vehicle, and the at least one operational characteristic is foreign substance accumulation along the substrate.

18. The system according to claim 14, wherein the at least one sensor is a resistive heating element of the pre-fabricated heater, the resistive heating element defining a sufficient temperature coefficient of resistance to function as a heater and as a sensor.

19. The system according to claim 14, wherein the controller provides power to the pre-fabricated heater based on a predetermined schedule when the motor vehicle is started.

20. The system according to claim 14, wherein the controller is configured to deploy the heated running board based on the at least one operational characteristic.
